(19) United States
(12) Patent Application Publication
(10) Pub. No.: US 2005/0174976 A1
(43) Pub. Date: Aug. 11, 2005

(54) Auto-switching channel method of unidirectional wireless receiver

(76) Inventor: Yung-Hui Wang, Taipei City (TW)

Correspondence Address: BIRCH STEWART KOLASCH & BIRCH, PO BOX 747, FALLS CHURCH, VA, 22040-0747, US

(21) Appl. No.: 10/775,208

(22) Filed: Feb. 11, 2004

(51) Int. Cl. H04Q 7/28

(52) U.S. Cl. 370/341; 370/329

(57) ABSTRACT

An auto-switching channel method of a unidirectional wireless receiver is disclosed. The method comprises: providing a unidirectional wireless receiver having an ID code, connected to a host; providing a wireless peripheral device, wherein said wireless peripheral device comprises an ID code that is same as the ID code of said unidirectional wireless receiver so that said wireless receiver and said wireless peripheral device are capable of communicating with each other, and wherein when said wireless receiver receives interference signal from said wireless peripheral device, said wireless receiver sends out a notification to notify a user to switch a channel of the ID code of said wireless peripheral device to a next operative channel, and after the user switches the channel of the ID code of said wireless peripheral device to said operative channel, a channel of ID code of said wireless receiver is automatically switched a channel that is same as said operative channel of said wireless peripheral device.

### BACKGROUND OF THE INVENTION

1. The field of the invention

The present invention generally relates to an auto-switching channel method of unidirectional wireless receiver, and more particularly an auto-switching channel method of unidirectional wireless receiver for communicating with wireless peripheral devices for avoiding interference by other wireless peripheral devices a longer period of time.

2. Description of related art

The general wireless computer input device comprises a wireless mouse (or a keyboard) and a wireless receiver. The wireless receiver is connected with the computer, and the wireless receiver has an ID code and a button for switching the channel. The wireless mouse (or keyboard) has a button for switching the channel and also has the ID code as the same as the wireless receiver's, thus the wireless receiver can receive the signal from the wireless mouse (or keyboard) and transmit the signal to the connected computer for data input.

However, interference by other wireless peripheral devices causes failure of wireless receiver to identify the ID code of the wireless mouse (or keyboard) and thereby adversely affecting the signal transmission. For avoiding such problem, a user must switch the channel ID code of the wireless mouse (or keyboard) by activating the button of the mouse (or the keyboard) and also the channel of the wireless receiver must be switch manually until the channel of the ID code of the wireless mouse (or keyboard) matches with the wireless receiver.

Therefore, how to solve the above defects of the conventional tool has become an important issue for the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create an auto-switching channel method for an unidirectional wireless receiver. The present invention provides an innovated cost effective auto-switching channel method for a unidirectional wireless receiver so that interferences by other wireless peripheral devices can be effectively reduced.

According to an aspect of the present invention, the auto-switching channel method enables the wireless receiver to detect the ID code of the connected wireless peripheral device (such as wireless mouse), and automatically switch the channel of the wireless receiver according to the detected ID code of the wireless peripheral device. Thus whenever the wireless receiver receives the interference signal from the wireless peripheral device, the wireless receiver sends out a signal to the connected computer and display on the display screen for notifying the user to switch the channel of the ID code of the wireless peripheral device. When user switches the channel of the ID code of the wireless peripheral device, the switched channel of the wireless peripheral device is detected, and the channel of the ID code of the wireless receiver is automatically switched according the switched channel of the wireless peripheral device. Therefore, the user need not manually switch the channel of the wireless receiver so that the wireless receiver can stay in communication with the wireless peripheral device for the longer period of time.

### BRIEF DESCRIPTION OF THE DRAWING

For a more complete understanding of the present invention, reference will now be made to the following detailed description of preferred embodiments taken in conjunction with the following accompanying drawings.

FIG. 1 is an elevational view of a wireless receiver and a wireless peripheral device connected to a host according to an embodiment of the present invention.

FIG. 2 is an operation flowchart of a wireless receiver according to an embodiment of the present invention.

FIG. 3 is an operation flowchart of a wireless peripheral device according to an embodiment of the present invention.

FIG. 4 is a block diagram of a circuit of a wireless receiver according to an embodiment of the present invention.

FIG. 5 is a block diagram of a circuit of a wireless peripheral device according to an embodiment of the present invention.

FIG. 6 is a view of a wireless receiver and a wireless peripheral device connected to a host according to another embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

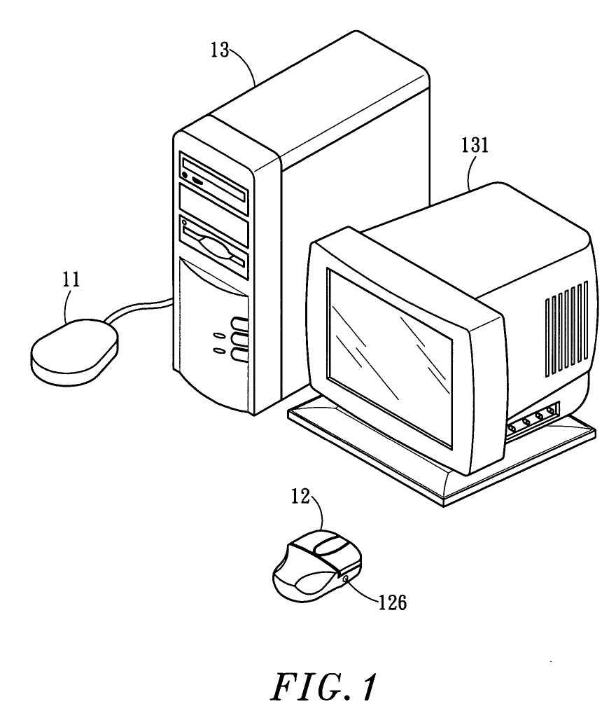

The present invention provides an auto-switching method of the unidirectional wireless receiver adapted for automatically switching the channel of the wireless receiver according to channel of the wireless peripheral device. Referring to FIG. 1, a wireless receiver 11 connected to a host 13 and a wireless peripheral device 12 (such as wireless mouse, keyboard and alike). The wireless peripheral device 12 has an ID code and a channel switching button 126 for switching the channel allowing the user to switch the channel of the ID code of the wireless peripheral device 12 by activating the channel switching button 126. The wireless receiver 11 has an ID code, which is same as the ID code of the wireless peripheral device 12 for enabling the wireless receiver 11 to communicate with the wireless peripheral device 12 via unidirectional signal transmission, for example, radio frequency (RF) signal via the host 13 (such as computer).

When the wireless receiver 11 receives an interference signal from the wireless peripheral device 12, the wireless receiver 11 transmits a notification signal to the host 13 and display the notification on the display screen 131 for notifying the user of the interference and to activate the channel switching button 126 of the wireless peripheral device 12 for switching the channel of the ID code. After the user switches to a different ID code channel, the switched channel of the wireless peripheral device is detected by the wireless receiver 11, the wireless receiver 11 automatically switches the channel of the ID code thereof into the channel which is same as the switched channel of the wireless peripheral device 12, thus the communication between the wireless receiver 11 and the wireless peripheral device 12 can be continued via a different channel without interference by other wireless peripheral devices.

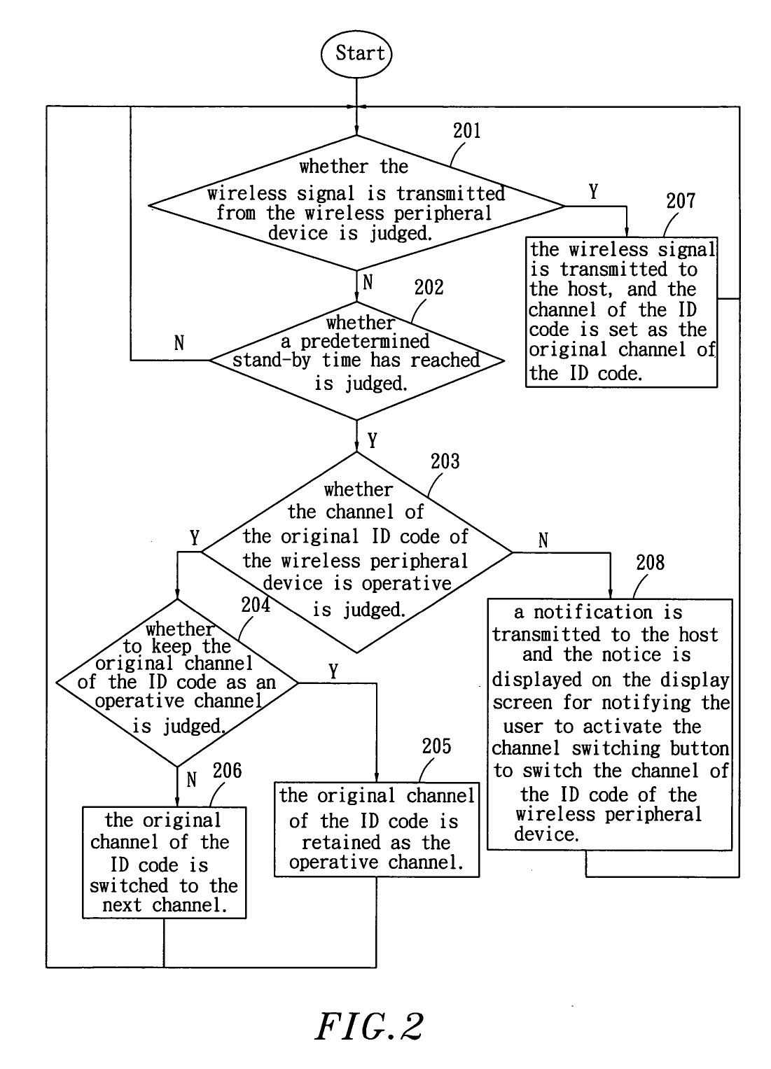

Referring to FIGS. 1 and 2, respectively show an elevational view and an operation flowchart of the wireless receiver according to an embodiment of the present invention. The procedure of receiving the signal by the wireless receiver 11 from the wireless peripheral device 12 is described as follows:
in step (201), whether the wireless signal is transmitted from the wireless peripheral device 12 is judged, if yes, then the procedure proceeds to step (207), and if not, then the procedure proceeds to step (202);
in step (202), whether a predetermined stand-by time has reached is judged, if yes, then the procedure proceeds to step (203), and if not, the procedure proceeds to step (201);
in step (203), whether the channel of the original ID code of the wireless peripheral device 12 is operative is judged, if yes, then the procedure proceeds to step (204), and if not, then the procedure proceeds to step (208);
in step (204), whether to keep the original channel of the ID code as an operative channel is judged, if yes, then the procedure proceeds to sep (205), and if not, then the procedure proceeds to step (206);
in step (205), the original channel of the ID code is retained as the operative channel, then the procedure proceeds to step (201);
in step (206), the original channel of the ID code is switched to the next channel, then the procedure proceeds to step (201);
in step (207), the wireless signal is transmitted to the host 13, and the channel of the ID code is set as the original channel of the ID code, then the procedure proceeds to step (201); and
in step (208), a notification is transmitted to the host 13 and the notice is displayed on the display screen 131 for notifying the user to activate the channel switching button 126 to switch the channel of the ID code of the wireless peripheral device 12, then the procedure proceeds to step (201).

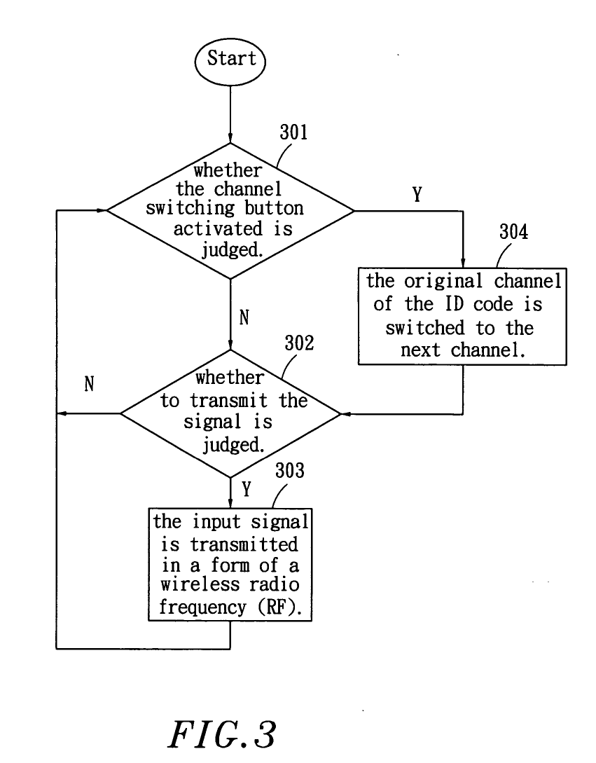

Referring to FIGS. 1 and 3, respectively show an elevational view and the operation flow chart of the wireless peripheral device according to an embodiment of the present invention. The operation procedure of the wireless peripheral device 12 can be illustrated as follows:
in step (301), whether the channel switching button 126 activated is judged, if yes, then the procedure proceeds to step (304), an if not, then the procedure proceeds to step (302);
in step (302), whether to transmit the signal is judged, if yes, the procedure proceeds to step (303), and if not, then the procedure proceeds to step (301);
in step (303), the input signal is transmitted in a form of a wireless radio frequency (RF), then procedure proceeds to step (301); and
in step (304), the original channel of the ID code is switched to the next channel, then the procedure proceeds to step (302).

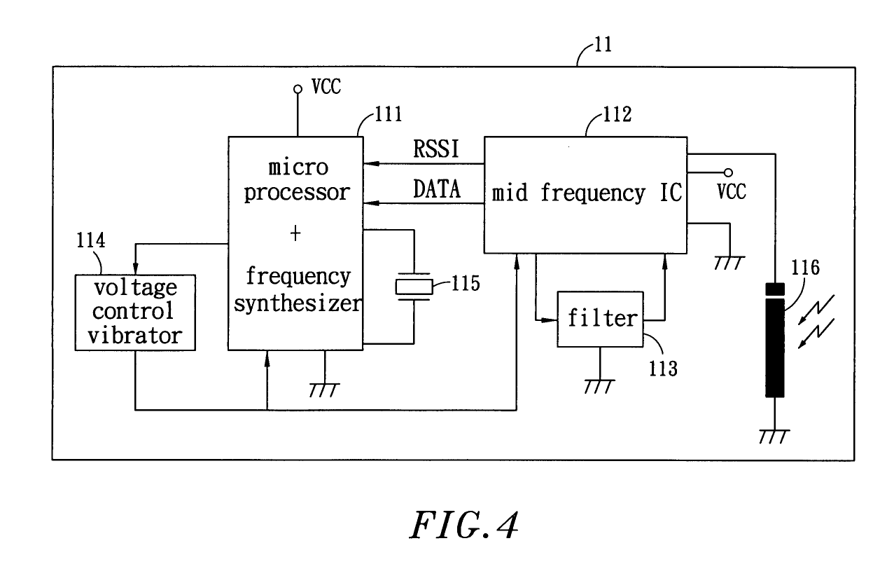

Referring FIG. 4, a block diagram of a circuit of a wireless receiver according to an embodiment of the present invention is shown. As shown, the wireless receiver 11 comprises a control circuit 111, a mid-frequency IC 112, a filter 113, a voltage control vibrator 114, a vibrator 115 and a receiving antenna 116. The control circuit 111 comprises a micro processor and the frequency synthesizer (PLL), wherein when switching the channel of the ID code, the frequency synthesizer generates a channel which is same as the wireless peripheral device 12 by using the voltage control vibrator 114 and the mid-frequency IC 112.

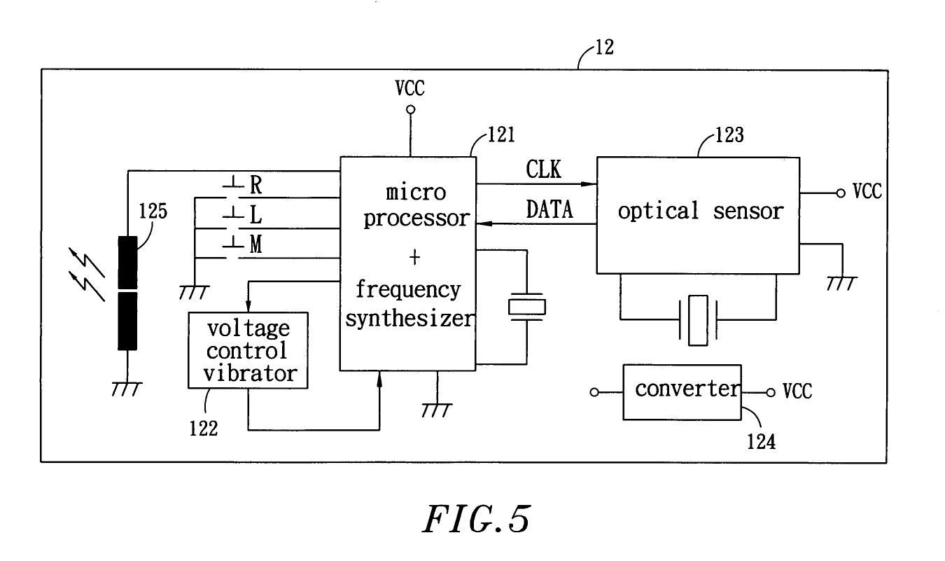

Now referring to FIG. 5, a block diagram of a circuit of a wireless peripheral device according to an embodiment of the present invention is shown. As shown, the wireless peripheral device 12 comprises a control circuit 121, a voltage control vibrator 122, an optical sensor 123, a converter 124 and a projecting antenna 125. The control circuit 121 has a micro processor and the frequency synthesizer (PLL), wherein when the channel switching button 126 activated (as shown in FIG. 1), the frequency synthesizer generates a channel using the voltage control vibrator 122, and the micro processor sends out the signal received by the optical sensor 123 via the projecting antenna 125 in the form of a wireless radio frequency (RF). The converter 124 converts the current of the battery (not shown) into a current suitable for the operation of the wireless peripheral device 12.

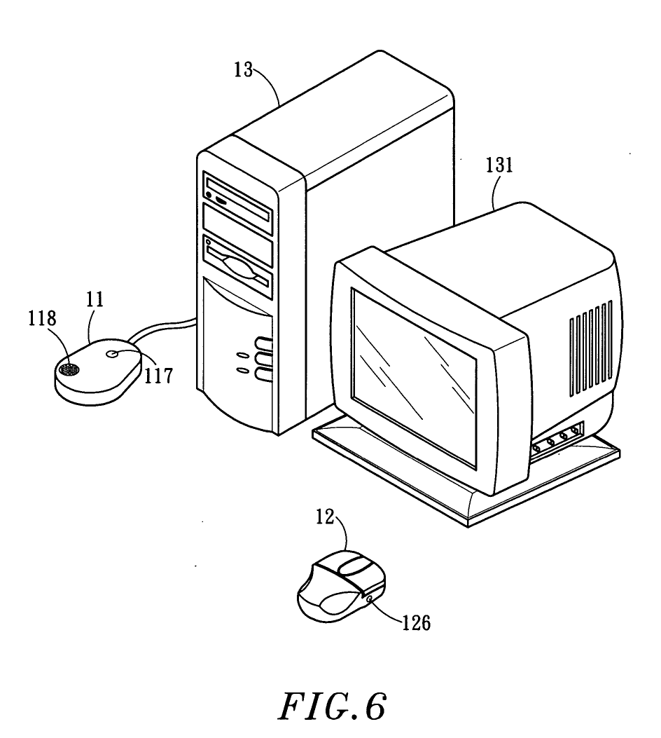

Referring FIG. 6, a view of a wireless receiver and wireless peripheral device connected to a host according to another embodiment of the present invention is shown. The wireless receiver 11 can also comprise an indicator light 117 or a speaker 118. The wireless receiver 11 can send a notification to the user to switch the channel of the ID code upon receiving an interference signal from the wireless peripheral device 12 by displaying the flashing indicator light 117 or playing preset sound via the speaker 118 to notify the user to activate the channel switching button 126 for switching the channel of the ID code of the wireless peripheral device 12.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. An auto-switching channel method of a unidirectional wireless receiver, comprising:
providing a unidirectional wireless receiver having an ID code, connected to a host;
providing a wireless peripheral device, wherein said wireless peripheral device comprises an ID code that is same as the ID code of said unidirectional wireless receiver so that said wireless receiver and said wireless peripheral device are capable of communicating with each other, and wherein when said wireless receiver receives interference signal from said wireless peripheral device, said wireless receiver sends out a notification to notify a user to switch a channel of the ID code of said wireless peripheral device to a next operative channel, and after the user switches the channel of the ID code of said wireless peripheral device to said operative channel, a channel of ID code of said wireless receiver is automatically switched a channel that is same as said operative channel of said wireless peripheral device.

2. The method according to claim 1, wherein said wireless peripheral device is a wireless mouse.

3. The method according to claim 1, wherein said wireless peripheral device is a wireless keyboard.

4. The method according to claim 1, wherein said wireless peripheral device comprises a channel switching button for allowing the user to switch said channel of ID code of said wireless peripheral device by activating said channel switching button.

5. The method according to claim 1, wherein said host is a computer.

6. The method according to claim 1, wherein a signal transmitted by said wireless peripheral device is a radio frequency (RF) signal.

7. The method according to claim 1, wherein said notification for notifying the user to switch channel is provided by displaying flashing of an indicator light installed on said wireless receiver.

8. The method according to claim 1, wherein said notification for notifying the user to switch channel is provided by playing a preset sound via an speaker installed on said wireless receiver.

9. The method according to claim 1, wherein said notification for notifying the user to switch channel is provided by displaying a notice on a display screen connected with said host.
